(19) United States
(12) Patent Application Publication
(10) Pub. No.: US 2006/0064405 A1
(43) Pub. Date: Mar. 23, 2006

(54) Hybrid client-server protocol for fast writes to a file

(76) Inventors: Xiaoye Jiang, Shrewsbury, MA (US); Uday K. Gupta, Westford, MA (US); Sorin Faibish, Newton, MA (US); Rui Liang, Natick, MA (US)

Correspondence Address: RICHARD AUCHTERLONIE;NOVAK DRUCE & QUIGG, LLP, 1000 LOUISIANA, SUITE 5320, HOUSTON, TX, 77002, US

(21) Appl. No.: 10/945,611

(22) Filed: Sep. 21, 2004

(51) Int. Cl. G06F 17/30

(52) U.S. Cl. 707/3

(57) ABSTRACT

A network file server has storage for storing a file system, and a computer programmed for access to the file system in accordance with a file access protocol and in accordance with a storage access protocol. The computer receives a file access request from a network client for access to a file in the file system in accordance with the network file access protocol. The computer decides whether it should finish the file access using the file access protocol or the client should finish the file access using the storage access protocol. Upon deciding that the client should finish the file access using the storage access protocol, the computer returns to the client metadata of the file including metadata specifying addresses of logical blocks of storage allocated to the file, and then the computer responds to storage access requests from the client by performing read-write access to the file.

### FIELD OF THE INVENTION

The present invention relates generally to data storage systems, and more particularly to network file servers.

### BACKGROUND OF THE INVENTION

In a data network it is conventional for a network server containing disk storage to service storage access requests from multiple network clients. The storage access requests, for example, are serviced in accordance with a network file access protocol such as the Network File System (NFS). (NFS is described, for example, in RFC 1094, Sun Microsystems, Inc., “NFS: Network File Systems Protocol Specification,” Mar. 1, 1989.)

A network file server typically includes a digital computer for servicing storage access requests in accordance with at least one network file access protocol, and an array of disk drives. The computer has been called by various names, such as a storage controller, a data mover, or a file server. The computer typically performs client authentication, enforces client access rights to particular storage volumes, directories, or files, and maps directory and file names to allocated logical blocks of storage.

Due to the overhead associated with the network file access protocol, the computer in the network file server may become a bottleneck to network storage access. This bottleneck can be bypassed if a client can be trusted to directly access the logical blocks of storage that have been allocated to the client's directories and files. For example, as described in Xu et al. U.S. Pat. No. 6,324,581 issued Nov. 27, 2001, incorporated herein by reference, a trusted client accesses a file by first obtaining a lock and metadata of the file from a metadata server, and then accessing the file in storage over a path that bypasses the metadata server.

In practice, the method of Xu et al. U.S. Pat. No. 6,324,581 has been most useful for large input/output (I/O) operations. The method of Xu et al. U.S. Pat. No. 6,324,581 has been used commercially in the following manner. If a trusted client requests a small I/O operation of less than a given threshold, for example four kilobytes, of data to be read or written to storage, then the computer in the network file server accesses the requested data on behalf of the client in the conventional fashion. In general, the threshold is smaller than the file system block size. If a trusted client requests a larger I/O operation of more than the threshold, then the computer in the network file server functions as a metadata server as described in Xu et al. U.S. Pat. No. 6,324,581 by placing a lock on the file to be accessed and returning metadata to the trusted client, and then the trusted client accesses the network storage directly over a path that bypasses the computer.

### SUMMARY OF THE INVENTION

It has been discovered that in some network storage systems, there is little advantage to providing a direct data path between the client and the network storage. In these network storage systems, there usually is sufficient bandwidth for transmission of data for large I/O operations over the data path between the client and the computer in the network file server and between the computer in the network file server and the network storage. Yet for large I/O operations, there is a significant loss of server processing capability if data transmission and certain metadata management operations are handled in the file access protocol and file system layers in the server's protocol stack. In this situation, the loading on the server can be reduced by using a hybrid client-server protocol in which the client uses a file access protocol for obtaining a lock and metadata of a file from the server, and then the client uses a storage access protocol to communicate with the server for reading or writing data to or from the server. In effect, some of the loading of the server is shifted to the client. If the loading on the server is relatively high and the loading on the client is relatively low, then the shifting of the loading to the client may provide the client with a fast write capability. Therefore, it may be advantageous for the storage system to select whether or not to use the hybrid client-server protocol depending on loading of the server, size or priority of the file access requests, priority of the clients, and/or policies of the clients.

In accordance with one aspect, the invention provides a method of operating a network file server. The network file server has storage for storing a file system, and a computer programmed for access to the file system in accordance with a file access protocol and programmed for reading from and writing to logical blocks of the file system in accordance with a storage access protocol. The method includes the computer receiving a file access request from a network client for access to a file in the file system in accordance with the network file access protocol, and the computer responding to the file access request by returning to the client metadata of the file including metadata specifying storage addresses of logical blocks of the file, and then the computer receiving a storage access request from the client requesting read-write access to specified logical blocks of the file in accordance with the storage access protocol, and the computer responding to the storage access request by performing read-write access to the file system in the storage.

In accordance with another aspect, the invention provides a network file server including storage for storing a file system, and a computer coupled to the storage and programmed for access to the file system in accordance with a file access protocol and programmed for reading from and writing to logical blocks of the file system in accordance with a storage access protocol. The computer is further programmed for receiving a file access request from a network client for access to a file in the file system in accordance with the network file access protocol, and for responding to the file access request by returning to the client metadata of the file including metadata specifying storage addresses of logical blocks of the file. The computer is also programmed for receiving a storage access request from the client requesting read-write access to specified logical blocks of the file in accordance with the storage access protocol, and for responding to the storage access request by performing read-write access to the file system in the storage.

### BRIEF DESCRIPTION OF THE DRAWINGS

Additional features and advantages of the invention will be described below with reference to the drawings, in which:

FIG. 1 is a block diagram of a data network including a network file server programmed to support a hybrid file access and storage access client-server protocol in accordance with the present invention;

FIG. 2 is a block diagram showing software modules in one of the data mover computers in the network file server in FIG. 1;

FIGS. 3 and 4 comprise a flowchart of programming in each of the data mover computers to enable the network file server of FIG. 1 to provide network client access to files in network storage in accordance with various file access protocols;

FIG. 5 is a flowchart of a procedure for deciding whether or not a data mover computer should use a hybrid file access and storage access protocol in response to a file access request from a network client; and

FIG. 6 is a is a block diagram showing software modules and remote direct memory access engines in one of the data mover computers in the network file server in FIG. 1.

While the invention is susceptible to various modifications and alternative forms, a specific embodiment thereof has been shown in the drawings and will be described in detail. It should be understood, however, that it is not intended to limit the invention to the particular form shown, but on the contrary, the intention is to cover all modifications, equivalents, and alternatives falling within the scope of the invention as defined by the appended claims.

### DETAILED DESCRIPTION OF THE PREFERRED EMBODIMENT

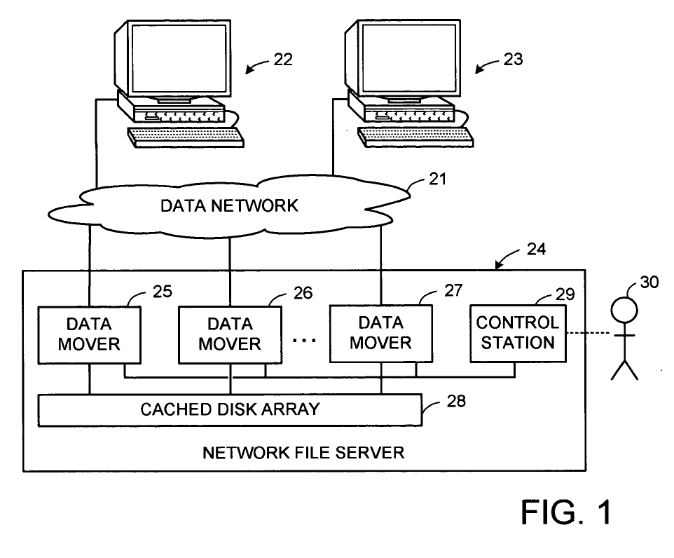

With reference to FIG. 1, there is shown a data processing system incorporating the present invention. The data processing system includes a data network 21 interconnecting a number of clients 22, 23 and servers such as a network file server 24. The data network 21 may include any one or more of network connection technologies, such as Ethernet, and communication protocols, such as TCP/IP. The clients 22, 23, for example, are workstations such as personal computers using either UNIX or Microsoft Windows operating systems. Various aspects of the network file server 24 are further described in Vahalia et al., U.S. Pat. No. 5,893,140 issued Apr. 6, 1999, incorporated herein by reference, and Xu et al., U.S. Pat. No. 6,324,581, issued Nov. 27, 2002, incorporated herein by reference. Such a network file server is manufactured and sold by EMC Corporation, 176 South Street, Hopkinton, Mass. 01748.

The network file server 24 includes a cached disk array 28 and a number of data mover computers, for example 25, 26, 27, and more. The network file server 24 is managed as a dedicated network appliance, integrated with popular network file systems in a way, which, other than its superior performance, is transparent to the end user. The clustering of the data movers 25, 26, 27 as a front end to the cache disk array 28 provides parallelism and scalability. Each of the data movers 25, 26, 27 is a high-end commodity computer, providing the highest performance appropriate for a data mover at the lowest cost. The network file server 24 also has a control station 29 enabling a system administrator 30 to configure and control the file server.

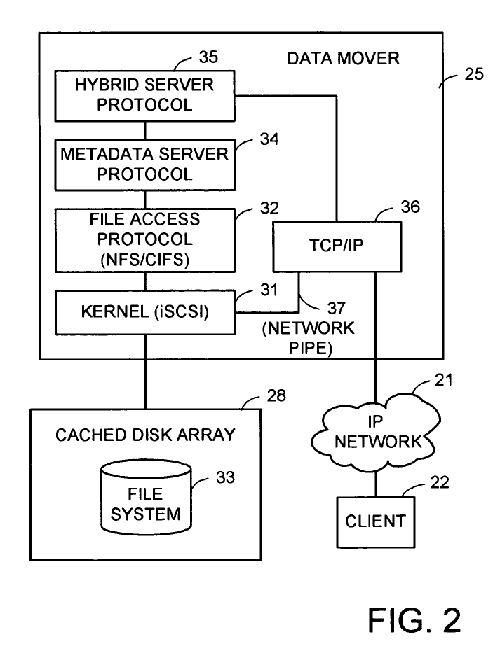

FIG. 2 shows software modules in the data mover 25 introduced in FIG. 1. The data mover 25 has a kernel module 31 for accessing network storage in the cached disk array 28 in accordance with a storage access protocol such as an Internet Protocol (IP) based Small Computer System Interface (iSCSI) protocol.

A file access protocol module 32 is layered over the kernel module 31. The file access protocol module 32 invokes the kernel module 31 to enable access to a file system 33 in the storage of the cached disk array 28. The file access protocol module 32, for example, permits the network client 22 to access the file system 33 in accordance with the Network File System (NFS) protocol or the Common Internet File System (CIFS) protocol.

A metadata server protocol module 34 is layered over the file access protocol module 32. The metadata server protocol module 32 permits a trusted network client to accesses a file by first obtaining a lock and metadata of the file from the data mover 25, and then accessing the file in storage over a path that bypasses the metadata server, as described in the above-cited Xu et al. U.S. Pat. No. 6,324,581 issued Nov. 27, 2001, incorporated herein by reference.

In accordance with an aspect of the present invention, a hybrid server protocol module 35 is layered over the metadata server protocol module 34. The hybrid server protocol module 35 is also layered over a TCP/IP module 36 for linking the hybrid server protocol module 35 and the kernel module 31 to the IP network 21. The hybrid server protocol module 35 permits a network client to access the file system 33 in the cached disk array 28 in accordance with a hybrid file access and storage access protocol.

In the hybrid server protocol, the network client 22 sends a file access request to the data mover 25 in accordance with a file access protocol. The data mover 25 responds by granting a lock on the file, setting up a pipe 37 for transfer of read-write requests and file data, and returning metadata to the client. The metadata specifies logical block addresses in the cached disk array 28 where the data of the file is stored. The client 22 uses the metadata to formulate read or write requests to the file in accordance with a storage access protocol such as the iSCSI protocol, and the client sends these storage access requests to the data mover 25. These storage access requests are piped through the TCP/IP module 36 to the kernel module 31, effectively bypassing the file access protocol module 32. Once the client 22 is finished accessing the file, the client returns a file close request including any new metadata resulting from the file access. For example, the client will return new metadata if additional logical blocks of storage have been allocated to the file as a result of the client appending data to the file. The data mover 25 commits this new metadata to the file system 33 in the storage of the cached disk array 28 and closes the file.

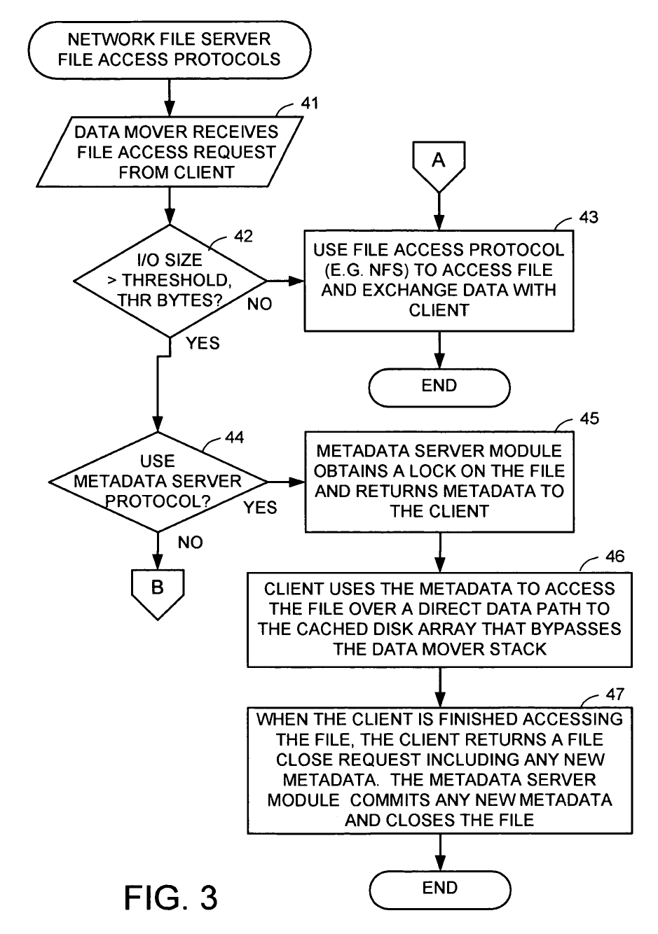

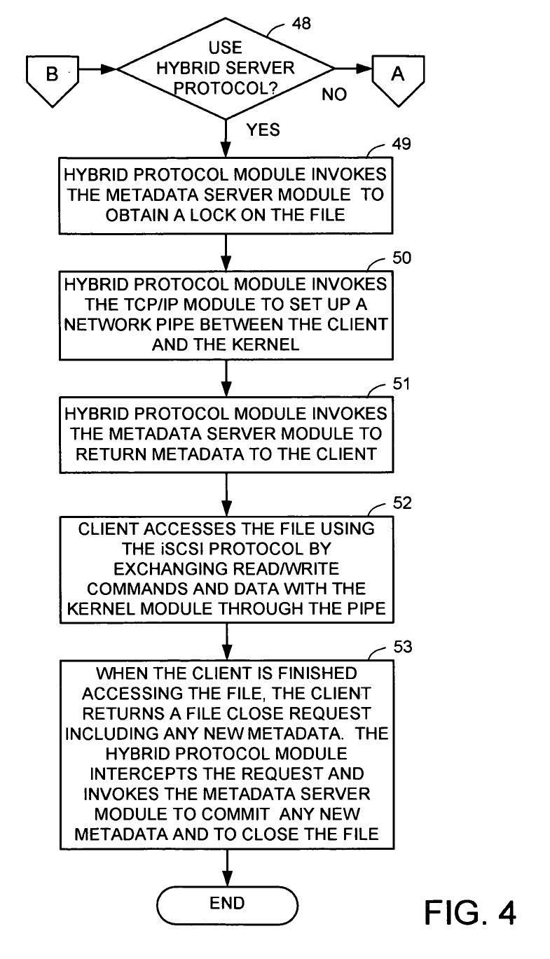

FIGS. 3 and 4 show how the network file server in FIG. 1 responds to a file access request from a network client in accordance with various aspects of the present invention. In a first step 41, the data mover receives a file access request from the client. In step 42, if the I/O size of the request is not greater than a threshold (THR), such as four kilobytes, then execution branches to step 43 and the data mover uses a file access protocol to access the file and exchange data with the client. Otherwise, if the I/O size is greater than the threshold (THR), then execution continues from step 42 to step 44.

In step 44, if the client is set up to use the metadata server protocol, then execution branches from step 44 to step 45. Use of the metadata server protocol requires the client to have a direct connection that bypasses the data mover for exchange of read-write commands and data between the client and the cached disk array. The data mover must also trust the client to access only the storage in the cached disk array that is allocated to the client. Therefore, the metadata server protocol will not be used unless the direct connection between the client and the cached disk array is a dedicated and secure connection or unless the cached disk array can verify the identity of the client and communicate with the client in a secure fashion. For example, the iSCSI protocol may use an Internet Storage Name Service (iSNS) server in order to ensure security.

In step 45, in accordance with the metadata server protocol, the metadata server module obtains a lock on the file and returns to the client metadata of the file specifying the storage addresses of logical data blocks allocated to the file. In step 46, the client uses the metadata to formulate read or write requests to access the file over a direct data path between the client and the cached disk array that bypasses the data mover. In step 47, when the client is finished accessing the file, the client returns a file close request including any new metadata. The metadata server module commits any new metadata and closes the file.

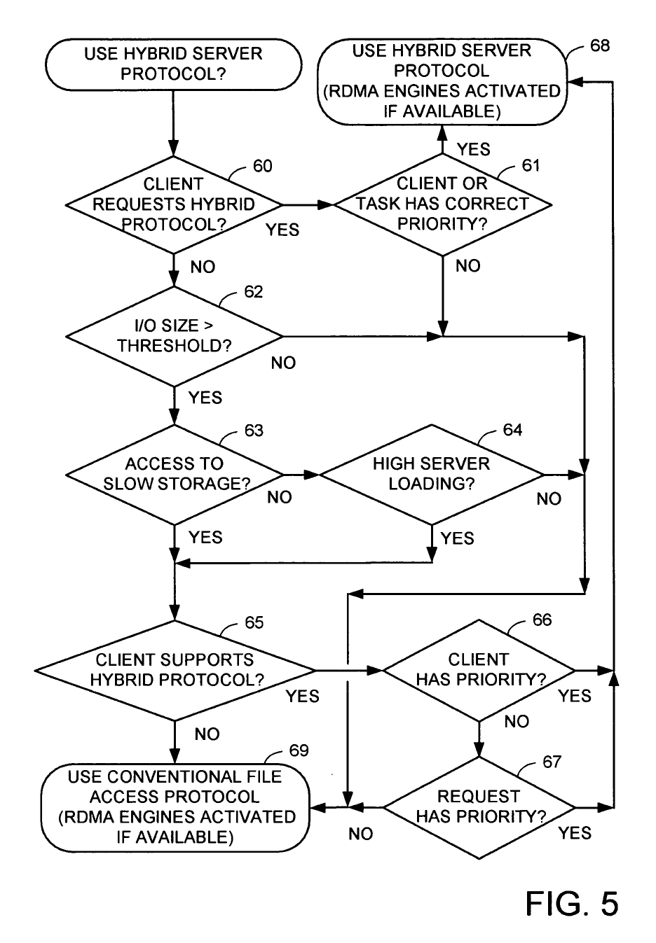

In step 44, if the metadata server protocol is not to be used, then execution continues from step 44 to step 48 of FIG. 4. In step 48, if the hybrid server protocol is not to be used, then execution loops back to step 43 in FIG. 3 to use the conventional file access protocol. In step 48, if the hybrid server protocol is to be used, then execution continues from step 48 to step 49 of FIG. 4. As will be described below with reference to FIG. 5, various factors can be considered in step 48 of deciding whether or not to use the hybrid server protocol.

The preferred hybrid server protocol includes steps 49 to 53 of FIG. 4. In step 49, the hybrid protocol module invokes the metadata server module to obtain a lock on the file. In step 50, the hybrid protocol module invokes the TCP/IP module to set up a network pipe between the client and the kernel for secure transmission of metadata to the client and read-write storage access requests from the client and exchange of data through the data mover between the client and the cached disk array. Communication through this pipe can use a secure network client authentication protocol such as Kerberos. If needed, the pipe can be dynamically opened for increased bandwidth in order to re-prioritize the pipe for a client on a task basis. The priority of a pipe for a client can be changed based on server workload while using the network file access protocol for serving lower priority clients or tasks running in a lower priority. In this fashion, a pipe can be opened for giving a fast-write capability to a priority client.

In step 51, the hybrid protocol module invokes the metadata server module to return metadata to the client including metadata specifying addresses in the cached disk array of logical blocks of storage allocated to the file. In step 52, the client accesses the file using the storage access protocol such as iSCSI by exchanging read/write commands and data with the kernel module through the pipe. In step 53, when the client is finished accessing the file, the client returns a file close request including any new metadata. The hybrid protocol module intercepts the request and invokes the metadata server module to commit any new metadata to storage and to close the file.

FIG. 5 is a flowchart of a procedure for deciding whether or not a data mover should use the hybrid file access and storage access protocol in response to a file access request from a network client. In a first step 60, if the client is requesting use of the hybrid protocol, then execution branches to step 61. For example, a client can be set up to request use of the hybrid protocol when it has excess processing resources and can tolerate a reduced quality of service to other possible tasks. In step 61, if the client or the client's task has a sufficient level of priority, then the hybrid protocol is used in step 68; otherwise, the conventional file access protocol is used in step 69.

In step 60, if the client is not requesting use of the hybrid protocol, then execution continues to step 62. In step 62, if the I/O size is greater than a certain threshold, then the data mover uses a conventional file access protocol in step 69. This threshold could be a function of the estimated loading on the data mover. For example, the threshold could be decreased for increased data mover loading, and increased for decreased data mover loading. The threshold could be a function of the speed of the storage to be accessed. For example, the threshold could be decreased for access to slow storage, and increased for access to fast storage.

In step 63, if the access is not to slow storage, then execution branches to step 64. For example, the storage in the cached disk array could include a set of conventional disk drives, which are relatively fast, and a set of serial access disk drives (such as ATA disk drives), which are relatively slow. In step 64, if there is not high server loading, then execution branches to step 69 to use the conventional file access protocol. If there is access to slow storage or if there is high server loading, then execution will continue from step 63 or step 64 to step 65. The objective here is to allocate additional bandwidth to the slow storage in order to speed up access to the slow storage, at the expense of offloading file server tasks to the client.

In step 65, if the client does not support the hybrid protocol, then execution branches from step 65 to use the conventional file access protocol. If the client supports the hybrid protocol, then execution continues from step 65 to step 66. If there are a number of clients that support the hybrid protocol, then the clients could be raked in an order of priority to be enabled for use of the hybrid protocol under high loading conditions. The objective here is to apply the hybrid protocol to selected clients that have available resources or can tolerate degradation in quality of service by taking on file server tasks to reduce the loading on the data mover.

In step 66, if the client has priority, then execution branches to step 68 use the hybrid server protocol. Otherwise, execution continues from step 66 to step 67. Step 66, for example, could be programmed by comparing a priority threshold to a respective priority level preassigned to each client. The priority threshold could be a function of data mover loading. For example, the priority threshold could initially be set to a low level, increased each time that step 66 is reached under high loading conditions, and decreased back toward the initial low level each time that step 66 is reached under low loading conditions.

In step 67, if the client“s file access request has priority, then execution branches to step 68 to use the hybrid server protocol. Step 67, for example, could be programmed by comparing the priority threshold to a respective priority level preassigned by the client to the file access request. In general, steps 61 and 67 permit each client to establish its own policy for deciding whether or not the file access protocol or the storage access protocol should be used for each of its file access requests based on various conditions. In step 67, if the client's file access request does not have priority, then execution continues to step 69 to use the conventional file access protocol

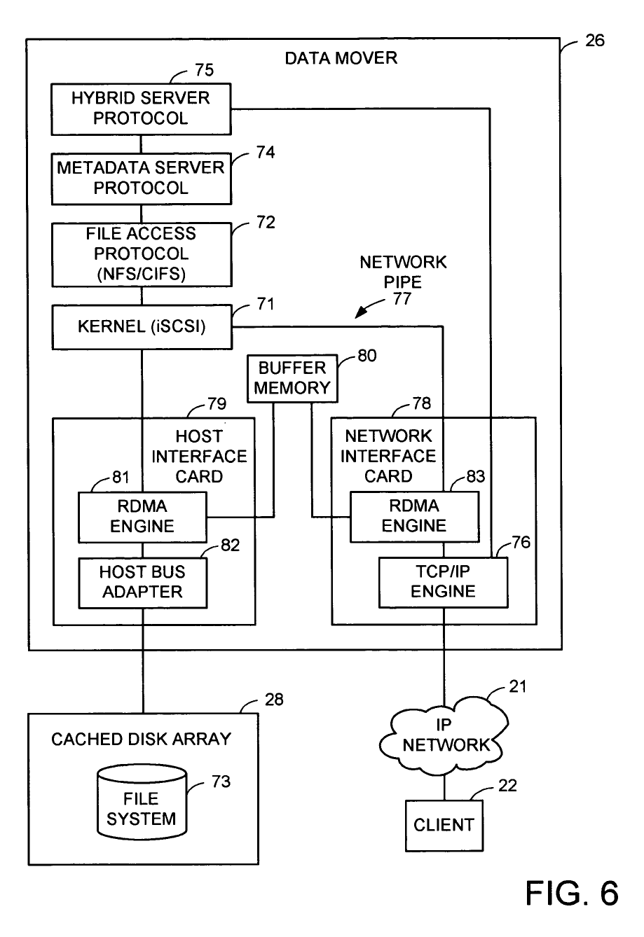

FIG. 6 shows a construction for the data mover 26 in which remote direct memory access (RDMA) engines 81, 83 are used for providing a network pipe 77 that not only bypasses the file access protocol layer 72 in the data mover protocol stack but also bypasses the kernel 71 during data transfer once the iSCSI routines in the kernel initiate a read or write in accordance with the storage access protocol. The protocol stack in the data mover 26 includes the kernel 71, the file access protocol layer 72, a metadata server protocol layer 74, and a hybrid server protocol layer 75. These protocol stack layers are similar to the protocol stack layers 31, 32, 34, and 35 described above with reference to FIG. 2.

The RDMA engines 81, 83, for example, are programmed to operate in accordance with protocols being established by the RDMA consortium organization and published on the Internet at “rdmaconsortium.org”. See, for example, John Hufferd et al., “iSCSI Extensions for RDMA Specification (Version 1.0),” draft-ko-iwarp-iser-v1.0, RDMA consortium organization, “rdmaconsortium.org,” July, 2003; and Mallikarjun Chadalapaka, “Datamover Architecture for iSCSI (DA) (Version 1.0),” draft-chadalapaka-iwarp-da-v1.0, RDMA consortium organization, “rdmaconsortium.org,” Jul. 21, 2003.

The data mover 26 includes a network interface card 78 linked to the IP network 21, a host interface card 79 linked to the cached disk array 28, and a buffer memory 80 dedicated to read and write data transfer between the IP network 21 and the cached disk array 28. The network interface card 78 includes a TCP/IP engine 76 linked to the IP network 21, and an RDMA engine 83 coupled to the buffer memory 80 and layered between the TCP/IP engine 76 and the iSCSI routines in the kernel 71. The host interface card 79 includes a host bus adapter 82 such as an SCSI or fibre channel (FC) adapter in accordance with the physical link between the data mover 26 and the cached disk array 28. The host interface card 79 also includes an RDMA engine 81 coupled to the buffer memory 80 and layered between the host bus adapter 82 and the kernel 71.

In operation, the iSCSI routines in the kernel respond to a read or write request from a network client 22 in accordance with the storage access protocol by initiating a read or write operation in which the transfer of the read or write data is handled by the RDMA engines 81 and 83. For a read operation, the RDMA engine 81 in the host interface card 79 transfers data from a file system 73 in the cached disk array 28 to the buffer memory 80, and the RDMA engine 83 in the network interface card 78 transfers the data from the buffer memory 80 to the client 22. For a write operation, the RDMA engine 83 in the network interface card 78 transfers data from the client 22 to the buffer memory 80, and the RDMA engine 81 in the host interface card 79 transfers the data from the buffer memory 80 to the cached disk array 82.

The RDMA engines 81, 83 can also be used for transfer of read and write data through the dedicated buffer memory 80 to complete long read and write operations in accordance with the file access protocol (NFS/CFS). For example, if a network client requests an I/O operation in accordance with the file access protocol and the I/O size is greater than the threshold (THR), then the programming of FIG. 5 may nevertheless select the conventional file access protocol (in step 69 of FIG. 5) due to access to slow storage or due to low client priority and low task or request priority. In the data mover 26 of FIG. 6, when the I/O size is greater than the threshold (THR) and the conventional file access protocol is selected for completing the requested read or write operation, the RDMA engines 81 and 83 are activated (in step 69 of FIG. 5) for transfer of the read or write data through the buffer memory 80 to bypass the kernel 71.

In view of the above, there has been described a network file server having storage for storing a file system, and a computer programmed for access to the file system in accordance with a file access protocol and in accordance with a storage access protocol. The computer receives a file access request from a network client for access to a file in the file system in accordance with the network file access protocol. The computer places a lock on the file, and decides whether or not it should finish the file access by using the file access protocol or whether the client should finish file access by using the storage access protocol. Upon deciding that the client should finish file access by using the storage access protocol, the computer returns to the client metadata of the file including metadata specifying addresses of logical blocks of the file, and then the computer responds to storage access requests from the client by performing read-write access to the file. In this fashion, the computer can improve quality of service by deciding whether or not it should finish the file access by using the file access protocol or whether the client should finish file access by using the storage access protocol, depending on loading of the server, size or priority of the file access requests, priority of the clients, and/or policies of the clients.

What is claimed is:

1. A method of operating a network file server, the network file server having storage for storing a file system, and a computer programmed for access to the file system in accordance with a file access protocol and programmed for reading from and writing to logical blocks of the file system in accordance with a storage access protocol, the method comprising:
the computer receiving a file access request from a network client for access to a file in the file system in accordance with the network file access protocol, and the computer responding to the file access request by returning to the client metadata of the file including metadata specifying storage addresses of logical blocks of the file, and then the computer receiving a storage access request from the client requesting read-write access to specified logical blocks of the file in accordance with the storage access protocol, and the computer responding to the storage access request by performing read-write access to the file system in the storage.

2. The method as claimed in claim 1, wherein the network file access protocol is the Network File System (NFS) protocol.

3. The method as claimed in claim 1, wherein the network file access protocol is the Common Internet File System (CIFS) protocol.

4. The method as claim 1, wherein the storage access protocol is a Small Computer System Interface (SCSI) protocol.

5. The method as claimed in claim 4, wherein the SCSI protocol is the Internet Small Computer System Interface (iSCSI) protocol.

6. The method as claimed in claim 1, which includes the computer responding to a file close request from the client by committing new metadata from the client to the storage and closing the file.

7. The method as claimed in claim 1, wherein the responding of the computer to the file access request further includes setting up a pipe for receiving the storage access request from the client requesting the read-write access to specified logical blocks of the file in accordance with the storage access protocol.

8. The method as claimed in claim 7, wherein the pipe conveys Transmission Control Protocol (TCP) data packets.

9. The method as claimed in claim 7, wherein a remote direct memory access (RDMA) protocol is used for conveying data through the pipe.

10. The method as claimed in claim 1, wherein the computer is programmed with a kernel layer coupled to the storage, a file access protocol layer over the kernel layer, a metadata server protocol layer over the file access protocol layer, and a hybrid server protocol layer over the metadata server protocol layer, and the method includes the kernel layer conducting the storage access protocol with the client, the file access protocol layer invoking the kernel layer to access metadata of the file system in the storage, and the file access protocol layer being invoked in response to the file access request from the client.

11. The method as claimed in claim 1, which includes the computer selectively providing network clients with read-write access to the file system in accordance with the storage access protocol based on loading of the computer, in order to provide network clients with read-write access to the file system in accordance with the storage access protocol in order to reduce loading on the computer.

12. The method as claimed in claim 1, which includes the computer selectively providing network clients with read-write access to the file system in accordance with the storage access protocol based on speed of the storage being accessed, in order to provide network clients with read-write access to the file system in accordance with the storage access protocol when the storage being accessed is relatively slow and to otherwise provide network clients with access to the file system in accordance with the network file access protocol when the storage being accessed is relatively fast.

13. The method as claimed in claim 1, which includes network clients specifying respective priorities for file access requests, and the computer selectively providing the network clients with read-write access to the file system in accordance with the storage access protocol based on the respective priorities of the file access requests specified by the clients.

14. A network file server comprising storage for storing a file system, and a computer coupled to the storage and programmed for access to the file system in accordance with a file access protocol and programmed for reading from and writing to logical blocks of the file system in accordance with a storage access protocol;
wherein the computer is programmed for receiving a file access request from a network client for access to a file in the file system in accordance with a network file access protocol, and for responding to the file access request by returning to the client metadata of the file including metadata specifying storage addresses of logical blocks of the file; and
wherein the computer is programmed for receiving a storage access request from the client requesting read-write access to specified logical blocks of the file in accordance with the storage access protocol, and for responding to the storage access request by performing read-write access to the file system in the storage.

15. The network file server as claimed in claim 14, wherein the network file access protocol is the Network File System (NFS) protocol.

16. The network file server as claimed in claim 14, wherein the network file access protocol is the Common Internet File System (CIFS) protocol.

17. The network file server as claimed in claim 14, wherein the storage access protocol is a Small Computer System Interface (SCSI) protocol.

18. The network file server as claimed in claim 17, wherein the SCSI protocol is the Internet Small Computer System Interface (iSCSI) protocol.

19. The network file server as claimed in claim 14, wherein the computer is programmed for responding to a file close request from the client by committing new metadata from the client to the storage and closing the file.

20. The network file server as claimed in claim 14, wherein the computer is further programmed for responding to the file access request by setting up a pipe for receiving the storage access request from the client requesting the read-write access to specified logical blocks of the file in accordance with the storage access protocol.

21. The network file server as claimed in claim 20, wherein the computer is programmed for setting up the pipe to convey Transmission Control Protocol (TCP) data packets in accordance with the storage access protocol.

22. The network file server as claimed in claim 20, wherein the computer is programmed for using a remote direct memory access (RDMA) protocol for conveying data through the pipe.

23. The network file server as claimed in claim 14, wherein the computer is programmed with a kernel layer coupled to the storage, a file access protocol layer over the kernel layer, a metadata server protocol layer over the file access protocol layer, and a hybrid server protocol layer over the metadata server protocol layer, and the kernel layer is programmed for conducting the storage access protocol with the client, the file access protocol layer is programmed for invoking the kernel layer to access metadata of the file system in the storage, and the computer is programmed to invoke the file access protocol layer in response to the file access request from the client.

24. The network file server as claimed in claim 14, wherein the computer is programmed for selectively providing network clients with read-write access to the file system in accordance with the storage access protocol based on loading of the computer, in order to provide network clients with read-write access to the file system in accordance with the storage access protocol in order to reduce loading on the computer.

25. The network file server as claimed in claim 14, wherein the computer is programmed for selectively providing network clients with read-write access to the file system in accordance with the storage access protocol based on speed of the storage being accessed, in order to provide network clients with read-write access to the file system in accordance with the storage access protocol when the storage being accessed is relatively slow and to otherwise provide network clients with access to the file system in accordance with the network file access protocol when the storage being accessed is relatively fast.

26. The network file server as claimed in claim 14, wherein the computer is programmed for selectively providing network clients with read-write access to the file system in accordance with the storage access protocol based on respective priorities of file access requests specified by the clients.
